(19) United States
(12) Patent Application Publication
(10) Pub. No.: US 2026/0055257 A1
(43) Pub. Date: Feb. 26, 2026

(54) METHOD FOR PRODUCING POLYTETRAFLUOROETHYLENE (PTFE) THORIUM OXIDE MEMBRANE

(71) Applicant: Jazze Marie Gorman, Houston, TX (US)

(72) Inventor: Jazze Marie Gorman, Houston, TX (US)

(21) Appl. No.: 18/811,570

(22) Filed: Aug. 21, 2024

(51) Int. Cl. C08K 3/22; B29C 48/00; B29C 48/08; B29C 48/14; B29C 48/28; B29C 48/285; B29C 48/88; B29C 48/91; B29C 48/92; B29C 48/95; B29K 27/18; B29K 105/00; B29K 105/16; B29K 509/00; B29L 7/00; C08J 3/20; C08K 5/42

(52) U.S. Cl. CPC C08K 3/22; B29C 48/0022; B29C 48/023; B29C 48/08; B29C 48/14; B29C 48/28; B29C 48/2883; B29C 48/91; B29C 48/9135; B29C 48/92; B29C 48/95; C08J 3/203; C08K 5/42; B29C 2948/92704; B29K 2027/18; B29K 2105/0032; B29K 2105/16; B29K 2509/00; B29K 2995/0063; B29K 2995/0094; B29K 2995/0097; B29L 2007/007; C08J 2327/18; C08K 2003/221

(57) ABSTRACT

The present disclosure relates to a method 200 for producing polytetrafluoroethylene (PTFE) thorium oxide membrane. The method 200 comprising combining metal oxide and polytetrafluoroethylene (PTFE) powder to form a first mixture and screening the first mixture to remove aggregates. The method 200 also comprising mixing a lubricant, wetting agent, and optional pigments to form a second mixture and spraying the second mixture over the first mixture. The method 200 also comprising compacting the homogeneous product into a preform and extruding and calendaring the preform to obtain a tape of desired thickness. The method 200 also comprising heating the tape formed to evaporate the lubricant and sintering the tape to fuse polytetrafluoroethylene (PTFE) and encapsulate the thorium oxide particles. The method 200 also comprising cooling the sintered tape at a controlled rate to prevent crack formation and maintain the integrity of the membrane structure.

### FIELD OF THE INVENTION

Embodiments of the present invention relate to a method for producing insulating membrane and specifically relates to a method for producing polytetrafluoroethylene (PTFE) thorium oxide membrane.

### DESCRIPTION OF THE RELATED ART

Recent developments in the aviation industry have led to a significant increase in the amount of electrical equipment on board aircraft. Additionally, the introduction of large-capacity aircraft and the drive to reduce the environmental impact of flights have prompted aircraft manufacturers to seek ways to minimize the weight of these aircraft.

In relation to the electric cables used in aircraft, these trends have spurred the development of cables capable of transmitting increasingly higher voltages without, if possible, altering their weight or dimensions. However, increasing the voltage under such conditions leads to the phenomenon of partial electric discharges in the cables, caused by the avalanche ionization of air. In this process, when electrons are exposed to an intense electrical field, they gain sufficient energy to ionize neutral molecules (such as those in the gases that make up air), creating new free electrons that can also ionize other neutral molecules. Once the voltage reaches a certain level, an electric arc is produced.

This phenomenon, commonly referred to as the corona effect, is influenced by various factors including the nature and temperature of the material where the discharge occurs and the ambient air pressure. As air pressure decreases, so does the voltage at which discharge occurs. Given that aircraft typically fly at an altitude of about 10,000 meters, where the pressure is approximately 200 to 300 hPa, flight conditions are conducive to the appearance of the corona effect.

When partial discharges occur in a cable with a conductive core covered by an insulating material, the material is subjected to various stresses. These include thermal stress due to a localized temperature increase in the area of the partial discharge, chemical stress resulting from the generation of ozone and nitric acid during the discharge, and mechanical stress due to surface erosion and the enlargement of pores within the material. These stresses contribute to the deterioration of the insulating material, leading to issues ranging from premature aging to the formation of cracks.

Therefore, there is need for an electric cable where the insulating material surrounding the conductive core is a matrix based on polyamide-imide or polyester-imide, as this material is effective in preventing the corona effect. One of the prominent solutions that offers both excellent electrical insulation properties and high-temperature resistance is polytetrafluoroethylene (PTFE) mixed with metal oxide.

Unfortunately, introducing metal oxides (also known as fillers) like titanium dioxide into extruded polytetrafluoroethylene (PTFE) in sufficient quantities to achieve an anti-corona effect has proven difficult. This introduction poses significant challenges. The presence of fillers in polytetrafluoroethylene (PTFE) increases its porosity, resulting in low-density polytetrafluoroethylene (PTFE). To mitigate the corona effect, it is crucial to limit the air content within the material, thereby minimizing the number of pores. Additionally, the inclusion of fillers in polytetrafluoroethylene (PTFE) complicates the extrusion process, leading to higher extrusion pressures and the risk of breakage during calendaring. although adding a lubricant to the composition can aid to a certain extent, but the lubricant tends to create pores during the drying phase, again resulting in a low-density material.

Therefore, there is a need for method that enables mixing polytetrafluoroethylene (PTFE) with a metal oxide, along with a lubricant to achieve desired level of insulation, while maintaining the material's integrity and performance.

Therefore, the present invention provides a method for producing polytetrafluoroethylene (PTFE) thorium oxide membrane.

### SUMMARY OF THE INVENTION

Embodiments of the present invention relate to a method for producing polytetrafluoroethylene (PTFE) thorium oxide membrane. The method includes combining a thorium oxide and a polytetrafluoroethylene (PTFE) resin powder to form a first mixture. The method also includes screening the first mixture to remove aggregates. The method also includes mixing a lubricant, wetting agent, and optional pigments to form a second mixture. The method also includes spraying the second mixture over the first mixture, and further mixing and screening the resulting product to achieve homogeneity. The method also includes compacting the homogeneous product into a preform. The method also includes extruding and calendaring the preform to obtain a tape of desired thickness. The method also includes heating the tape formed to evaporate the lubricant. The method also includes sintering the tape to fuse polytetrafluoroethylene (PTFE) and encapsulate the thorium oxide particles. The sintering involves heating above the crystalline melting point of polytetrafluoroethylene (PTFE) but below the melting point of thorium oxide. The method also includes cooling the sintered tape at a controlled rate to prevent crack formation and maintain the integrity of the membrane structure.

In accordance with an embodiment of the present invention, the cooling temperature is controlled gradually to avoid structural damage.

In accordance with an embodiment of the present invention, the temperature is slowly and steadily increased during sintering for preventing prevent oxidation and/or contamination.

In accordance with an embodiment of the present invention, the inert gasses such as nitrogen or argon are used to create an inert atmosphere during sintering.

In accordance with an embodiment of the present invention, the preform is compacted into a cylindrical shape with predetermined dimensions.

In accordance with an embodiment of the present invention, a predetermined amount of pressure is applied to form a cylindrical preform.

In accordance with an embodiment of the present invention, the tape is heated in an oven to a predetermined temperature level to evaporate the lubricant.

In accordance with an embodiment of the present invention, the method also includes trimming the tape to a desired dimension and packaging.

In accordance with an embodiment of the present invention, the tape is coiled or wound onto a universal reel during packaging.

In accordance with an embodiment of the present invention, the method further includes preparing a solvent mixture prior to the formulation of the first mixture.

In accordance with an embodiment of the present invention, the solvent mixture is prepared by mixing a saturated solvent and a sodium dioctyl sulfosuccinate until the wetting agent is fully dissolved.

In accordance with an embodiment of the present invention, the isoparafinic solvent and sodium dioctyl sulfosuccinate is mixed in ratio of 90:10.

In accordance with an embodiment of the present invention, the solvent mixture is added to the polytetrafluoroethylene (PTFE) resin in a pre-determined ratio and is mixed for a predetermined period to completely wet the resin.

In accordance with an embodiment of the present invention, the solvent mixture and the polytetrafluoroethylene (PTFE) resin is mixed in ratio of 80:20.

In accordance with an embodiment of the present invention, the pro-longed mixing ensures a uniform distribution of the thorium oxide within the polytetrafluoroethylene (PTFE) matrix.

Another embodiment of the present invention relates to a polytetrafluoroethylene (PTFE) thorium oxide membrane composition. The composition also comprising polytetrafluoroethylene resin. The composition also comprising saturated solvent. The composition also comprising sodium dioctyl sulfosuccinate. The composition also comprising thorium oxide powder.

In accordance with an embodiment of the present invention, the saturated solvent is either a paraffin or an isoparaffin

In accordance with an embodiment of the present invention, the polytetrafluoroethylene (PTFE) resin is in powdered form.

In accordance with an embodiment of the present invention, the thorium oxide powder is 10% by weight with respect to the polytetrafluoroethylene (PTFE) resin.

In accordance with an embodiment of the present invention, the sodium dioctyl sulfosuccinate is a wetting agent.

### BRIEF DESCRIPTION OF THE DRAWINGS

So that the manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1 illustrates a flowchart for a method for producing polytetrafluoroethylene (PTFE) thorium oxide membrane, in accordance with an embodiment of the present invention; and

FIG. 2 illustrates a block diagram showcasing constituents of a polytetrafluoroethylene (PTFE) thorium oxide membrane composition, in accordance with an embodiment of the present invention.

It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE INVENTION

In the following detailed description, numerous specific details are set forth in order to provide a thorough understanding of the embodiment of the invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well-known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

### The Following Brief Definition of Terms Shall Apply Throughout the Present Invention

The terms “determining”, “measuring”, “evaluating”, “assessing,” “assaying,” and “analyzing” can be used interchangeably herein to refer to any form of measurement, and include determining if an element is present or not. (e.g., detection). These terms can include both quantitative and/or qualitative determinations. Assessing may be relative or absolute.

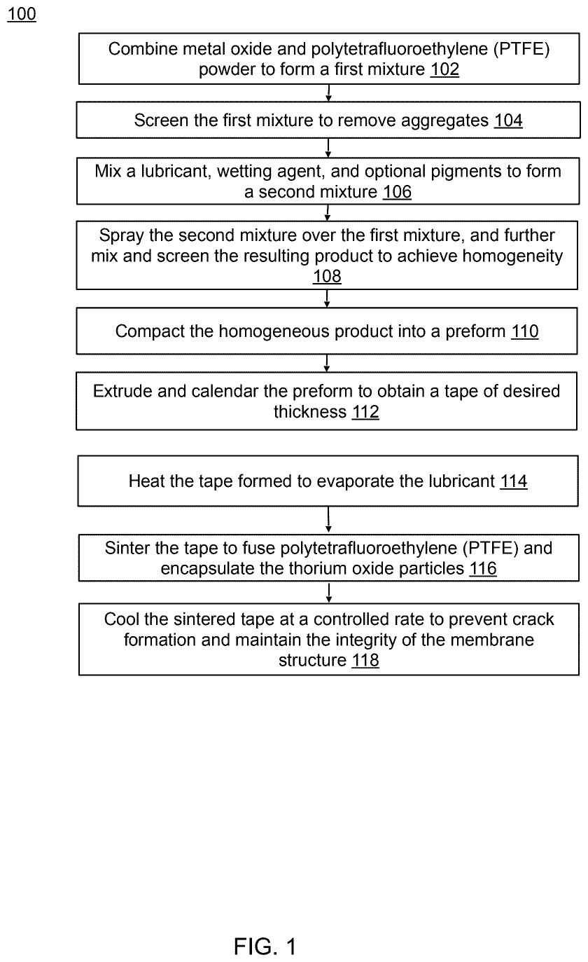

FIG. 1 illustrates a flowchart for a method 100 for producing polytetrafluoroethylene (PTFE) thorium oxide membrane, in accordance with an embodiment of the present invention. From here on, the thorium oxide powder is also referred to as thorium oxide. The method 100 may comprise following steps.

At 102, combining a thorium oxide 208 and a polytetrafluoroethylene (PTFE) resin 202 powder to form a first mixture.

At 104, screening the first mixture to remove aggregates.

At 106, mixing a lubricant, wetting agent, and optional pigments to form a second mixture.

At 108, spraying the second mixture over the first mixture, and further mixing and screening the resulting product to achieve homogeneity.

At 110, compacting the homogeneous product into a preform.

At 112, extruding and calendaring the preform to obtain a tape of desired thickness.

At 114, heating the tape formed to evaporate the lubricant.

At 116, sintering the tape to fuse polytetrafluoroethylene (PTFE) and encapsulate the thorium oxide 208 particles. The sintering involves heating above the crystalline melting point of polytetrafluoroethylene (PTFE) but below the melting point of thorium oxide 208.

At 118, cooling the sintered tape at a controlled rate to prevent crack formation and maintain the integrity of the membrane structure.

The cooling temperature may be controlled gradually to avoid structural damage.

The temperature may be slowly and steadily increased during sintering for preventing prevent oxidation and/or contamination.

The inert gasses such as nitrogen or argon may be used to create an inert atmosphere during sintering.

The preform may be compacted into a cylindrical shape with predetermined dimensions.

The predetermined amount of pressure may be applied to form a cylindrical preform.

The tape may be heated in an oven to a predetermined temperature level to evaporate the lubricant.

The method may also include trimming the tape to a desired dimension and packaging.

The tape may be coiled or wound onto a universal reel during packaging.

The method further may include preparing a solvent mixture prior to the formulation of the first mixture.)

The solvent mixture may be prepared by mixing an saturated solvent 204 and a sodium dioctyl sulfosuccinate 206 until the wetting agent is fully dissolved.

The isoparafinic solvent 204 and sodium dioctyl sulfosuccinate 206 may be mixed in ratio of 90:10.

The solvent mixture may be added to the polytetrafluoroethylene (PTFE) resin 202 in a pre-determined ratio and is mixed for a predetermined period to completely wet the resin.

The solvent mixture and the polytetrafluoroethylene (PTFE) resin 202 may be mixed in ratio of 80:20.

The pro-longed mixing may ensure a uniform distribution of the thorium oxide 208 within the polytetrafluoroethylene (PTFE) matrix.

In an embodiment of the present disclosure, mixture of the polytetrafluoroethylene (PTFE) resin 202 and the sodium dioctyl sulfosuccinate 206 is mixed for 2 hours at a temperature of 80° C. (176 F). Subsequently, at the same temperature 80° C. (176 F), the thorium oxide powder 208 with particle size between 50 and 100 nm is added and mixed for 2 hours to obtain a uniform distribution of the thorium oxide 208 within the polytetrafluoroethylene (PTFE) matrix.

In an embodiment of the present disclosure, the performing of the mixture is carried by loading it into the cylinder and exerting a pressure of 150 psi. In some embodiments, the extrusion of the preform of the mixture may form a ribbon. In an embodiment of the present disclosure, at a temperature of 49° C. (120F) the extrusion may be carried out, whilst maintaining a speed of 120 and 200 inches/min until achieving a final desired tape or ribbon thickness.

In an embodiment of the present disclosure, the tape formed may be heated at 121° C. (250F) to achieve evaporation of the rest of the Isopar M. In an embodiment of the present disclosure, during sintering the tape formed involves heating the material above the crystalline melting point of polytetrafluoroethylene (PTFE), i.e., 330° C. (626° F.) but below the melting point of thorium oxide 208, allowing the polytetrafluoroethylene (PTFE) resin 202 to fuse and encapsulate the thorium oxide 208 particles. During sintering a slow and steady increase in temperature is recommended at 20° C./5 min. Cooling after sintering is performed at a controlled rate with air at 25° C. to prevent crack formation and maintain the integrity of the membrane structure.

In an embodiment of the present disclosure, the dimensions of cylinder during extrusion and calendaring may be 30 cm height and 10 cm diameter. The preforms then extruded and calendared to obtain a tape of thickness 76 μm.

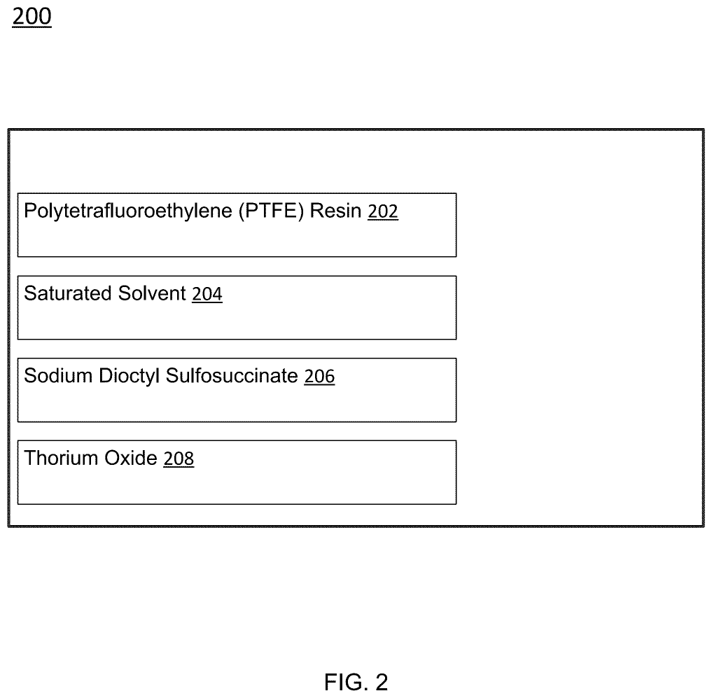

FIG. 2 illustrates a block diagram showcasing constituents of a polytetrafluoroethylene (PTFE) thorium oxide membrane composition 200, in accordance with an embodiment of the present invention.

The composition 200 may comprise comprising polytetrafluoroethylene (PTFE) resin 202, saturated solvent 204, sodium dioctyl sulfosuccinate 206, and thorium oxide powder 208.

The saturated solvent is either a paraffin or an isoparaffin

In a preferred embodiment, the saturated solvent 204 may be Isopar M. In some embodiments, the saturated solvent 204 may be Soltrol, Isopar, Solvenpar L, Kerosene, and so

The polytetrafluoroethylene (PTFE) resin 202 may be in powdered form.

The thorium oxide powder 208 may be 10% by weight with respect to the polytetrafluoroethylene (PTFE) resin 202.

The sodium dioctyl sulfosuccinate 206 may be a wetting agent.

In an alternative embodiment, the mixture of the saturated solvent 204 and the sodium dioctyl sulfosuccinate 206 is prepared in the same 90/10 ratio but mixed at a lower temperature of to dissolve the wetting agent. Further, the mixing of the polytetrafluoroethylene (PTFE) resin 202 and the solvent mixture may be performed at a lower temperature to ensure uniform distribution of the thorium oxide 208 within the polytetrafluoroethylene (PTFE) matrix.

In an alternative embodiment, the mixture of the saturated solvent 204 and the sodium dioctyl sulfosuccinate 206 is prepared and added to polytetrafluoroethylene (PTFE) resin 202, where the resin-to-solvent ratio may vary. In an alternative embodiment, the mixture of the saturated solvent 204 and the sodium dioctyl sulfosuccinate 206 is prepared in the same 90/10 ratio but mixed at a higher temperature of to dissolve the wetting agent. Further, the mixing of the polytetrafluoroethylene (PTFE) resin 202 and the solvent mixture may be performed at a higher temperature to ensure uniform distribution of the thorium oxide 208 within the polytetrafluoroethylene (PTFE) matrix.

In an alternative embodiment, the composition 200 may comprise the thorium oxide 208 powder with a finer particle size range of 20 to 50 nanometers, allowing a more homogeneous distribution of smaller particles, potentially enhancing the overall performance of the composite membrane. In an alternative embodiment, the mixing time may be extended to ensure extremely uniform dispersion and consistency in the tape formed.

In an embodiment of the present disclosure, the humectant may be an anionic surfactant that can be of the sulfate or sulfonate type, it can also be phosphates and phosphanates but preferably a sodium dioctyl sulfosuccinate.

In an embodiment of the present disclosure, the mixing of the polytetrafluoroethylene (PTFE) 202 with metal oxide, a lubricant, a wetting agent, and optionally, a pigment may comprise preparing a first mixture that includes the metal oxide and powdered polytetrafluoroethylene (PTFE) 202, and thereafter preparing a second mixture consisting of the lubricant, wetting agent, and optional pigment. This two-stage process of mixing significantly reduces the presence of aggregates, leading to a more uniformity. This also allows the subsequent calendaring to substantially reduce thickness of the tape formed.

In an embodiment of the present disclosure, pressure during calendaring may exceed 150 bar to achieve the desired tape thickness and smoothness. In an embodiment of the present disclosure, drying of the sintered tape may be conducted at temperatures ranging from 130° C. to 230° C. The tape formed may be delivered uncured when it is intended as a starting material or cured when it has already been formed into the finished product. The curing step is performed in an oven at temperatures below 450° C., preferably below 400° C.

In a preferred embodiment, the polytetrafluoroethylene (PTFE) resin 202 powder is 9002-84-0 PTFE 601X or Daikin F107. In a preferred embodiment, the Isopar M is from shell. In a preferred embodiment, the sodium dioctyl sulfosuccinate 206 is 577-11-7 dioctyl sulfosuccinate sodium salt (humectant). In a preferred embodiment, the thorium oxide powder 208 is 1314-20-1 ThO2 nano-powder with particle size between 50 and 100 nm diameter.

In an exemplary embodiment, the composition 200 may serve an electrical insulator, making it particularly suitable for the production of electric cables. The characteristics of this material make it an ideal choice for applications in the aviation industry. For an instance, the composition 200 may be used to create an electric cable wound around a conductive core. The term “conductive core” refers to a strand capable of conducting electricity, such as a copper or alumina strand several millimeters in diameter, which may be optionally treated with silver to enhance conductivity. The cable may consist of one or more conductive cores, which can be surrounded by a polyimide film, before being wrapped with one or more tapes made from the composition 200.

In an exemplary embodiment, the method 200 may also include winding the tape formed around a conductive core and thereafter curing the cable at a temperature below 450° C., preferably below 400° C.

In another exemplary embodiment, the composition 200 may be used as an electrical insulator, especially in the aviation sector. Beyond its anti-corona effect, the composition 200 may also offers significant heat resistance, making it a valuable asset for high-performance electrical insulation in demanding environments. The advantage of the disclosed invention is also apparent through a comparative analysis for the two formulations of polytetrafluoroethylene (PTFE) material, as presented in table 1.

TABLE 1
Comparison of Two Formulations of the
Polytetrafluoroethylene (PTFE) Material

| | 1^{st} Formulation | 2^{nd} Formulation |
|---|---|---|
| PTFE powder (kg) | 10 | 10 |
| Filler | ThO₂ | Al₂O₃ |
| Quantity of filler (kg) | 1 | 1 |
| Grain size (nm) | 500 | 100 |
| Specific surface area (m²/g) | 10-50 m2/g | 10 |
| Isobar ™ (kg) | 2.5 | 2.9 |
| Density (in finished product) | 1.5 | 1.38 |

The disclosed invention may be utilized in a variety of real-world applications. The disclosed invention may be used in High-Frequency Printed Circuit Boards (PCBs). As polytetrafluoroethylene (PTFE) is often used in high-frequency PCBs due to its excellent dielectric properties. The addition of thorium oxide could potentially enhance the thermal stability and mechanical strength of such boards. The disclosed invention may be employed for thermal sealing and insulation: The thermal resistance of polytetrafluoroethylene (PTFE) makes it suitable for sealing and insulation in high-temperature environments. Thorium oxide's high melting point could further improve such properties.

Due to low friction and wear resistance properties, the disclosed invention is ideal for use in bearings and lubrication. The inclusion of thorium oxide 208 could enhance the wear resistance and longevity of such components. The PTFE's chemical inertness allows the disclosed invention to be used in various clinical applications, such as implants and biomedical instrumentation.

Further, the thorium oxide 208 may provide radiation shielding properties, which makes the disclosed invention suitable for certain medical devices. Furthermore, the radiation shielding properties of the thorium oxide 208 make the disclosed invention a suitable candidate for aerospace and defense applications, where protection against radiation is crucial.

In addition to this, mixing of the polytetrafluoroethylene (PTFE) resin 202 with the thorium oxide 208 provides a range of enhanced properties that make the disclosed invention material highly valuable in demanding applications. The thorium oxide 208 significantly boosts the dielectric strength of polytetrafluoroethylene (PTFE) resin 202, making it highly effective at withstanding and mitigating partial electrical discharges, including the corona effect. This is crucial in high-voltage environments, where insulation failure can lead to catastrophic consequences.

The addition of the thorium oxide 208 also imparts superior thermal stability to the polytetrafluoroethylene (PTFE) resin 202, allowing it to endure extreme temperatures without degrading or losing its insulating capabilities. Thus, makes the disclosed invention well-suited for use in environments that experience wide temperature fluctuations or sustained high temperatures.

Furthermore, as the thorium oxide 208 enables resistance to radiation and UV exposure, it contributes to the mechanical strength of the disclosed invention. This enhances mechanical strength improves resistance to wear, abrasion, and deformation, which can prolong the lifespan of components subjected to mechanical stresses.

Moreover, the incorporation of the thorium oxide 208 into the polytetrafluoroethylene (PTFE) resin 202 also helps in reducing porosity, leading to a denser and more homogenous structure. This reduction in porosity is beneficial for minimizing the presence of air pockets that could potentially compromise insulating properties and durability.

Overall, the disclosed invention results in a membrane that offers exceptional electrical, thermal, and mechanical performance, making it ideal for use in advanced technological applications where reliability and safety are paramount.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed for:

1. A method for producing polytetrafluoroethylene (PTFE) thorium oxide membrane, the method comprising:
combining a thorium oxide and a polytetrafluoroethylene (PTFE) resin powder to form a first mixture;
screening the first mixture to remove aggregates;
mixing a lubricant, wetting agent, and optional pigments to form a second mixture;
spraying the second mixture over the first mixture, and further mixing and screening the resulting product to achieve homogeneity;
compacting the homogeneous product into a preform;
extruding and calendaring the preform to obtain a tape of desired thickness;
heating the tape formed to evaporate the lubricant;
sintering the tape to fuse polytetrafluoroethylene (PTFE) and encapsulate the thorium oxide particles,
wherein the sintering involves heating above the crystalline melting point of polytetrafluoroethylene (PTFE) but below the melting point of thorium oxide; and
cooling the sintered tape at a controlled rate to prevent crack formation and maintain the integrity of the membrane structure.

2. The method of claim 1, wherein the cooling temperature is controlled gradually to avoid structural damage.

3. The method of claim 1, wherein the temperature is slowly and steadily increased during sintering for preventing prevent oxidation and/or contamination.

4. The method of claim 3, wherein the inert gasses such as nitrogen or argon are used to create an inert atmosphere during sintering.

5. The method of claim 1, wherein the preform is compacted into a cylindrical shape with predetermined dimensions.

6. The method of claim 5, wherein a predetermined amount of pressure is applied to form a cylindrical preform.

7. The method of claim 1, wherein the tape is heated in an oven to a predetermined temperature level to evaporate the lubricant.

8. The method of claim 1, wherein the method also includes trimming the tape to a desired dimension and packaging.

9. The method of claim 8, wherein the tape is coiled or wound onto a universal reel during packaging.

10. The method of claim 1, wherein the method further includes preparing a solvent mixture prior to the formulation of the first mixture.

11. The method of claim 10, wherein the solvent mixture is prepared by mixing an saturated solvent and a sodium dioctyl sulfosuccinate until the wetting agent is fully dissolved.

12. The method of claim 11, wherein the isoparafinic solvent and sodium dioctyl sulfosuccinate is mixed in ratio of 90:10.

13. The method of claim 10, wherein the solvent mixture is added to the polytetrafluoroethylene (PTFE) resin in a pre-determined ratio and is mixed for a predetermined period to completely wet the resin

14. The method of claim 13, wherein the solvent mixture and the polytetrafluoroethylene (PTFE) resin is mixed in ratio of 80:20.

15. The method of claim 13, wherein the pro-longed mixing ensures a uniform distribution of the thorium oxide within the polytetrafluoroethylene (PTFE) matrix.

16. A polytetrafluoroethylene (PTFE) thorium oxide membrane composition, the composition comprising:
polytetrafluoroethylene (PTFE) resin;
saturated solvent;
sodium dioctyl sulfosuccinate; and
thorium oxide powder.

17. The composition of claim 16, wherein the saturated solvent is either a paraffin or an isoparaffin.

18. The composition of claim 16, wherein the polytetrafluoroethylene (PTFE) resin is in powdered form.

19. The composition of claim 16, wherein the thorium oxide powder is 10% by weight with respect to the polytetrafluoroethylene (PTFE) resin.

20. The composition of claim 16, wherein the sodium dioctyl sulfosuccinate is a wetting agent.
